(19) United States
(12) Patent Application Publication
(10) Pub. No.: US 2005/0113045 A1
(43) Pub. Date: May 26, 2005

(54) Bridged ultra-wideband communication method and apparatus

(76) Inventors: John Santhoff, San Diego, CA (US); Steven A. Moore, Escondido, CA (US); Bruce W. Watkins, San Marcos, CA (US)

Correspondence Address: PULSE-LINK, INC., 1969 KELLOGG AVENUE, CARLSBAD, CA, 92008, US

(21) Appl. No.: 10/719,903

(22) Filed: Nov. 21, 2003

(51) Int. Cl. H04B 1/00

(52) U.S. Cl. 455/130

(57) ABSTRACT

Systems, methods and apparatus are provided for bridging data between different communication formats, or protocols. One embodiment of the present invention comprises a communication system that bridges data between a substantially continuous carrier wave format and an ultra-wideband format. The present invention may be used in wireless and wire communication networks such as hybrid fiber-coax-networks. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### FIELD OF THE INVENTION

The present invention generally relates to the field of communications. More particularly, the present invention concerns methods and apparatus for communication between different communication media and architectures.

### BACKGROUND OF THE INVENTION

The Information Age is upon us. Access to vast quantities of information through a variety of different communication systems are changing the way people work, entertain themselves, and communicate with each other. Faster, more capable communication technologies are constantly being developed. For the manufacturers and designers of these new technologies, achieving “interoperability” is becoming an increasingly difficult challenge.

Interoperability is the ability for one device to communicate with another device, or to communicate with another network, through which other communication devices may be contacted. However, with the explosion of different communication protocols (i.e., the rules communications equipment use to transfer data), designing true interoperability is not a trivial pursuit.

For example, most wireless communication devices employ conventional, narrowband “carrier wave” technology that employs a specific radio frequency band, while other devices use electro-optical technology. In addition to wireless communications, data is also transmitted through wire media, such as fiber optic cable, co-axial cable, twisted-pair wire and other types of wire media. Generally, each one of these communication technologies employ their own rules, or protocols for transferring data.

Another type of communication technology is ultra-wideband (UWB). UWB technology is fundamentally different from conventional, narrowband radio frequency technology. UWB employs a “carrier free” architecture, which does not require the use of high frequency carrier generation hardware, carrier modulation hardware, frequency and phase discrimination hardware or other devices employed in conventional frequency domain communication systems. Of course, UWB has its own set of communication protocols.

Therefore, there exists a need for apparatus and methods that enable communication between different communication media, technologies, and architectures.

### SUMMARY OF THE INVENTION

The present invention provides a system, methods, and apparatus that can communicate between, or “bridge” between different communications technologies. In one embodiment of the present invention, a conventional narrowband radio frequency receiver receives data. The data is then demodulated and retransmitted using ultra-wideband (UWB) communication technology. The communication may be through either wireless or wire media.

In another embodiment of the present invention, an UWB receiver receives data through a first transmission medium. The data is then demodulated and retransmitted across a second transmission medium using UWB communication technology. The first and second transmission media may be wireless or wire.

In a still further embodiment of the present invention, an UWB receiver receives data from a first transmission medium. The data is then demodulated and retransmitted by a conventional narrowband radio frequency transmitter. The communication may be through either wireless or wire media.

One feature of the present invention is that it enables communication between different communication technologies, media and architectures.

The foregoing and other features and advantages of the present invention will be appreciated from review of the following detailed description of the invention, along with the accompanying FIG.ures in which like reference numerals refer to like parts throughout.

### BRIEF DESCRIPTION OF THE DRAWING

FIG. 1 is an illustration of different communication methods;

FIG. 2 is an illustration of two ultra-wideband pulses;

FIG. 3 illustrates the frequency spectrum of various communications signals;

FIG. 4 illustrates the demodulation of a conventional, narrowband amplitude-modulated signal and re-transmission using an ultra-wideband communication format;

FIG. 5 illustrates the receipt of ultra-wideband formatted data and re-transmission of the data using a carrier-based amplitude-modulated signal;

FIG. 6 illustrates demodulation of a conventional, narrowband QAM signal and re-transmission using an ultra-wideband communication format;

FIG. 7 illustrates the receipt of ultra-wideband formatted data and re-transmission of the data using a carrier-based QAM signal;

FIG. 8 illustrates the receipt and coherent demodulation of a continuous, narrowband signal and re-transmission using an ultra-wideband communication format;

FIG. 9 illustrates the reception and non-coherent demodulation of a conventional, narrowband angle modulated signal and re-transmission using an ultra-wideband communication format;

FIG. 10 illustrates the reception and demodulation of a conventional, narrowband angle modulated signal using a phase-locked-loop and re-transmission using an ultra-wideband communication format;

FIG. 11 illustrates the reception of ultra-wideband formatted data and re-transmission of the data using a phase angle-modulated continuous sine wave;

FIG. 12 illustrates the reception of ultra-wideband formatted data and re-transmission of the data using a frequency angle-modulated continuous sine wave;

FIG. 13 illustrates the reception of data using one type of ultra-wideband format and re-transmission of the data using another type of ultra-wideband format;

FIG. 14 illustrates the reception of ultra-wideband formatted data and re-transmission of the data using an OFDM continuous sine wave;

FIG. 15 illustrates the reception and demodulation of a conventional, narrowband OFDM signal and re-transmission using an ultra-wideband communication format;

FIG. 16 is an illustration of an ultra-wideband communication gateway constructed according to one embodiment of the present invention;

FIG. 17 is an illustration of a front view, and schematic views of a power supply transceiver constructed according to one embodiment of the present invention;

FIG. 18 is an illustration of a front view, a perspective schematic phantom view, and a functional block illustration of a coaxial cable transceiver constructed according to one embodiment of the present invention; and

FIG. 19 is an illustration of a front view, a perspective schematic phantom view, and a functional block illustration of a phone line or Category 5 Ethernet transceiver constructed according to one embodiment of the present invention.

It will be recognized that some or all of the figures are schematic representations for purposes of illustration and do not necessarily depict the actual relative sizes or locations of the elements shown. The figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides a system, methods, and apparatus that can communicate between, or “bridge” between different communications technologies. For example, a television viewer in a residence may request a movie from a DVD player, that is in another room of the residence. The request may travel from the TV set-top-box to an ultra-wideband (UWB) enabled home gateway, that generates a UWB datastream, which is transmitted on the home's power line. The gateway may send a request to the DVD player through the power line. The DVD player may then send the video stream to the gateway via a UWB datastream modulated on a S-Video interface. The home gateway may then route the return DVD data via a UWB wireless link back to the TV's set-top-box. All these routing decisions are intelligently made and executed without user intervention.

One feature of the present invention is that it intelligently bridges UWB communications to and from all interfaced media. For example, the coaxial cable interfaced to the home gateway may have a UWB datastream coexisting with other frequency modulated data. The present invention detects and extracts the encoded UWB data from the coax cable, then determines the destination and optimal routing of the data. For example, the data enters the home on coax, but may routed from the home gateway via a UWB wireless link. Alternatively, it may routed from the home gateway on twisted pair or through the home's electrical power lines.

One aspect of the present invention is that it employs ultra-wideband (UWB) technology. One form of UWB communication is “carrier free,” which does not require the use of high frequency carrier generation hardware, carrier modulation hardware, stabilizers, frequency and phase discrimination hardware or other devices employed in conventional frequency domain communication systems. That is, conventional radio frequency technology, sometimes referred to herein as “narrowband,” or “narrowband radio frequency communication,” employs continuous sine waves that are transmitted with data embedded in the modulation of the sine waves' amplitude or frequency. For example, a conventional cellular phone must operate at a particular frequency band of a particular width in the total frequency spectrum. Specifically, in the United States, the Federal Communications Commission has allocated cellular phone communications in the 800 to 900 MHz band. Cellular phone operators use 25 MHz of the allocated band to transmit cellular phone signals, and another 25 MHz of the allocated band to receive cellular phone signals.

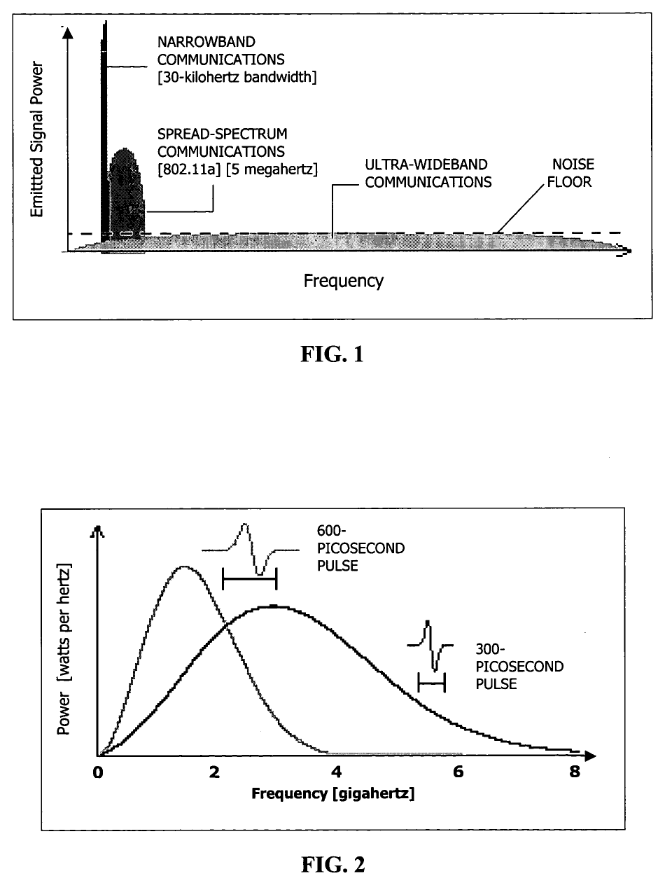

Referring to FIG. 1, another example of a conventional radio frequency technology is illustrated. 802.11a, a wireless local area network (LAN) protocol, transmits continuous sinusoidal radio frequency signals at a 5 GHz center frequency, with a radio frequency spread of about 5 MHz.

In contrast, ultra-wideband (UWB) communication technology employs discrete pulses of electromagnetic energy that are emitted at, for example, nanosecond or picosecond intervals (generally tens of picoseconds to a few nanoseconds in duration). For this reason, ultra-wideband is often called “impulse radio.” That is, the UWB pulses are transmitted without modulation onto a sine wave carrier frequency, in contrast with conventional, narrowband radio frequency technology as described above. A UWB pulse is a single electromagnetic burst of energy. A UWB pulse can be either a single positive burst of electromagnetic energy, or a single negative burst of electromagnetic energy, or a single burst of electromagnetic energy with a predefined phase. Alternate implementations of UWB can be achieved by mixing discrete pulses with a carrier wave that controls a center frequency of a resulting UWB signal. Ultra-wideband generally requires neither an assigned frequency nor a power amplifier.

In contrast to the relatively narrow frequency spread of conventional communication technologies, a UWB pulse may have a 2.0 GHz center frequency, with a frequency spread of approximately 4 GHz, as shown in FIG. 2, which illustrates two typical UWB pulses. FIG. 2 illustrates that the narrower the UWB pulse in time, the broader the spread of its frequency spectrum. This is because bandwidth is inversely proportional to the time duration of the pulse. A 600-picosecond UWB pulse can have about a 1.6 GHz center frequency, with a frequency spread of approximately 1.6 GHz. And a 300-picosecond UWB pulse can have about a 3 GHz center frequency, with a frequency spread of approximately 3.2 GHz. Thus, UWB pulses generally do not operate within a specific frequency, as shown in FIG. 1. And because UWB pulses are spread across an extremely wide frequency range or bandwidth, UWB communication systems allow communications at very high data rates, such as 100 megabits per second or greater. A UWB pulse constructed according to the present invention may have a duration that may range between about 10 picoseconds to about 100 nanoseconds.

Further details of UWB technology are disclosed in U.S. Pat. No. 3,728,632 (in the name of Gerald F. Ross, and titled: Transmission and Reception System for Generating and Receiving Base-Band Duration Pulse Signals without Distortion for Short Base-Band Pulse Communication System), which is referred to and incorporated herein in its entirety by this reference.

Also, because the UWB pulse is spread across an extremely wide frequency range, the power sampled at a single, or specific frequency is very low. For example, a UWB one-watt pulse of one nano-second duration spreads the one-watt over the entire frequency occupied by the UWB pulse. At any single frequency, such as at the carrier frequency of a CATV provider, the UWB pulse power present is one nano-watt (for a frequency band of 1 GHz). This is calculated by dividing the power of the pulse (1 watt) by the frequency band (1 billion Hertz). This is well within the noise floor of any communications system and therefore does not interfere with the demodulation and recovery of the original signals. Generally, for wireless communication, the multiplicity of UWB pulses are transmitted at relatively low power (when sampled at a single, or specific frequency), for example, at less than −30 power decibels to −60 power decibels, which minimizes interference with conventional radio frequencies. However, UWB pulses transmitted through most wire media will not interfere with wireless radio frequency transmissions. Therefore, the power (sampled at a single frequency) of UWB pulses transmitted though wire media may range from about +30 dBm to about −140 dBm.

The present invention may be employed in any type of network, be it wireless, wired, or a mix of wire media and wireless components. That is, a network may use both wire media, such as coaxial cable, and wireless devices, such as satellites, or cellular antennas. As defined herein, a network is a group of points or nodes connected by communication paths. The communication paths may be connected by wires, or they may be wirelessly connected. A network as defined herein can interconnect with other networks and contain subnetworks. A network as defined herein can be characterized in terms of a spatial distance, for example, such as a local area network (LAN), a personal area network (PAN), a metropolitan area network (MAN), a wide area network (WAN), and a wireless personal area network (WPAN), among others. A network as defined herein can also be characterized by the type of data transmission technology in use on it, for example, a TCP/IP network, and a Systems Network Architecture network, among others. A network as defined herein can also be characterized by whether it carries voice, data, or both kinds of signals or data. A network as defined herein can also be characterized by who can use the network, for example, a public switched telephone network (PSTN), other types of public networks, and a private network (such as within a single room or home), among others. A network as defined herein can also be characterized by the usual nature of its connections, for example, a dial-up network, a switched network, a dedicated network, and a nonswitched network, among others. A network as defined herein can also be characterized by the types of physical links that it employs, for example, optical fiber, coaxial cable, a mix of both, unshielded twisted pair, and shielded twisted pair, among others.

The present invention may also be employed in any type of wireless network, such as a wireless PAN, LAN, MAN, WAN or WPAN. The present invention can be implemented in a “carrier free” architecture, which does not require the use of high frequency carrier generation hardware, carrier modulation hardware, stabilizers, frequency and phase discrimination hardware or other devices employed in conventional frequency domain communication systems. The present invention dramatically increases the bandwidth of conventional networks that employ wire media, but can be inexpensively deployed without extensive modification to the existing wire media network.

Another feature of the present invention is that it employs a variety of different methods of modulating a multiplicity of ultra-wideband pulses. The pulses can be transmitted and received wirelessly, or through any wire medium, whether the medium is twisted-pair wire, coaxial cable, fiber optic cable, or other types of wire media.

Yet another feature of the present invention is that it provides an UWB pulse transmission method that increases the available bandwidth of a communication system by enabling the simultaneous transmission of conventional carrier-wave signals and UWB pulses.

The different modulation and UWB pulse transmission methods enable the simultaneous coexistence of the ultra-wideband pulses with conventional carrier-wave signals. The present invention may be used in wireless and wire communication networks such as hybrid fiber-coax networks.

Thus, the ultra-wideband pulses transmitted according to the methods of the present invention enable an increase in the bandwidth, or data rates of a communication system.

One feature of the present invention has the capability to receive and transmit UWB, and non-UWB data over a multitude of media types. The present invention may perform the physical interface, logic and routing functions of bridging, or transferring UWB, and non-UWB data between dissimilar conductive media types. As mentioned above, the present invention provides a system, methods, and apparatus that can communicate between, or “bridge” between different communications technologies. Generally, these communication technologies are designed and characterized by the type of communication media that they employ. Broadly, virtually all communication media can be grouped into two types: wire and wireless. Additionally, this invention is concerned with essentially two types of communication: ultra-wideband (UWB—as defined above), and conventional, narrowband radio frequency (RF) technology, as also defined above. Combining the above four choices (wire, wireless, UWB and conventional) results in the following TABLE 1, which lists the possible combinations of communication technology and transmission media.

TABLE 1

| | | |
|---|---|---|
| Wire UWB | [symbol] | Wire UWB |
| Wire UWB | [symbol] | Wire Conventional |
| Wire UWB | [symbol] | Wireless UWB |
| Wire UWB | [symbol] | Wireless Conventional |
| Wireless UWB | [symbol] | Wire UWB |
| Wireless UWB | [symbol] | Wire Conventional |
| Wireless UWB | [symbol] | Wireless UWB |
| Wireless UWB | [symbol] | Wireless Conventional |
| Wire Conventional | [symbol] | Wire UWB |
| Wire Conventional | [symbol] | Wire Conventional |
| Wire Conventional | [symbol] | Wireless UWB |
| Wire Conventional | [symbol] | Wireless Conventional |
| Wireless Conventional | [symbol] | Wire UWB |
| Wireless Conventional | [symbol] | Wire Conventional |
| Wireless Conventional | [symbol] | Wireless UWB |
| Wireless Conventional | [symbol] | Wireless Conventional |

Some of the above combinations are well known, such as wire conventional to wire conventional, or wireless conventional to wireless conventional. Thus techniques to bridge, or transfer data between these types of known combinations are also known. However, one feature of the present invention is that it may be employed as a communication bridge between known combinations, for a variety of reasons. For example, a bridge node, or communication bridge constructed according to the present invention may receive a narrowband, or conventional wire signal containing data and subsequently transmit the data through another wire, using a conventional, narrowband sine wave carrier.

However, the bridge node may perform several functions during the receipt and subsequent transmission of the data, whether it is received in via narrowband or UWB technology. For example, functions that may be performed by the present invention include receiving, transmitting, input/output (I/O) control, routing, addressing, modulation, demodulation, load balancing, appropriate UWB pulse width and envelope shape determination for the media, appropriate UWB pulse transmission rate determination, buffering and reformatting.

As shown in TABLE 1, it is anticipated that the received data may or may not include data that is transmitted using UWB pulses. Many different types of wire media may be employed by the present invention. For example, the wire media may include any combination of fiber optic cable, coax, powerline, and copper media such as phone lines or CAT 5 network cabling. These media may be thought of a the “physical layer” of a communication system. The “physical layer” may also include the specific types of connectors used on a communication device, for example, an S-video cable interface (for audio and video), Ethernet ports, IEEE 1394 and USB ports, and other busses, or connectors. The “physical layer” may also include the computer processor. These may be microprocessors, digital signal processors, general purpose processors, or finite state machines.

In a communication system, the data that is transported through the media (wire or wireless), and manipulated by the computer processors, is managed, in part, by the Media Access Control (MAC). The MAC comprises a protocol, or set of rules that determine, in part, when and how data is to be received, demodulated, modulated and transmitted. Thus, communication systems employ both a MAC and an physical layer (or PHY).

Different conventional narrowband communication standards and networks, as defined above, have their own MAC's. For example, DOCSIS is a cable modem standard, and Bluetooth is a LAN standard. Many of these MACs cannot communicate with each other. One feature of the present invention is that it can communicate with different MACs. That is, data may be received using one protocol, or set of communication rules, and subsequently transmitted using another set of communication rules.

Alternatively, the present invention may interface with different physical layers, or PHY's. In this embodiment, the present invention may comprise one, or more MACs that can communicate with different PHYs. This enables the present invention function as a “bridge” between different communication technologies.

Generally, with regard to ultra-wideband communication, one embodiment of the present invention bridges datastreams between different media by controlling one or more variables. For example, these variables may include: the UWB pulse transmission rate; pulse power; pulse duration; pulse envelope shape; and data modulation technique for the media. In media where the UWB datastream must coexist with other data, a pseudo-random pulse transmission rate may be employed.

For example, when communicating through wire media used for CATV, several variables must be considered. The radio frequency spectrum generated by a UWB pulse is directly related to the UWB pulse's width (as described above) and its shape. The inherent bandwidth limitations of some transmission media may require longer duration pulses. For example, the downstream bandwidth available in the North American CATV market is approximately 750 MHz. This corresponds to UWB pulse durations of approximately 1.3 nanoseconds. Thus, in this communication environment, UWB pulse duration may be adjusted.

However, in a wireless environment, pulse durations in the hundreds of picoseconds may be desirable. When bridging data between these media (CATV to wireless), the transmitted pulse duration may be different than the received pulse duration. In order to avoid interfering with CATV signals, the overall shape of the UWB pulse may be manipulated to adjust the distribution of the pulse's spectral energy. In an environment where there are known narrowband transmitters present, notch filters may be employed to prevent UWB pulse energy in that portion of the spectrum. Some of these considerations may be different between wireless and wire media. One feature of the present invention is that these variables, as well as others, are considered, and corresponding adjustments, such as adjustment of pulse width, are performed, which allows for optimization of the UWB pulses to a particular media type, and communication protocol.

Common to all forms of electromagnetic communication is modulation of the carrier signal by a data source. The signal may comprise a conventional, narrowband sine wave, or it may comprise a plurality of ultra-wideband pulses. A number of modulation schemes are well known in the communication art. The following is a discussion of a number of different data modulation methods that may employed by the present invention. For example, data modulated as described below may be received and/or transmitted by a communication bridge constructed according to the present invention.

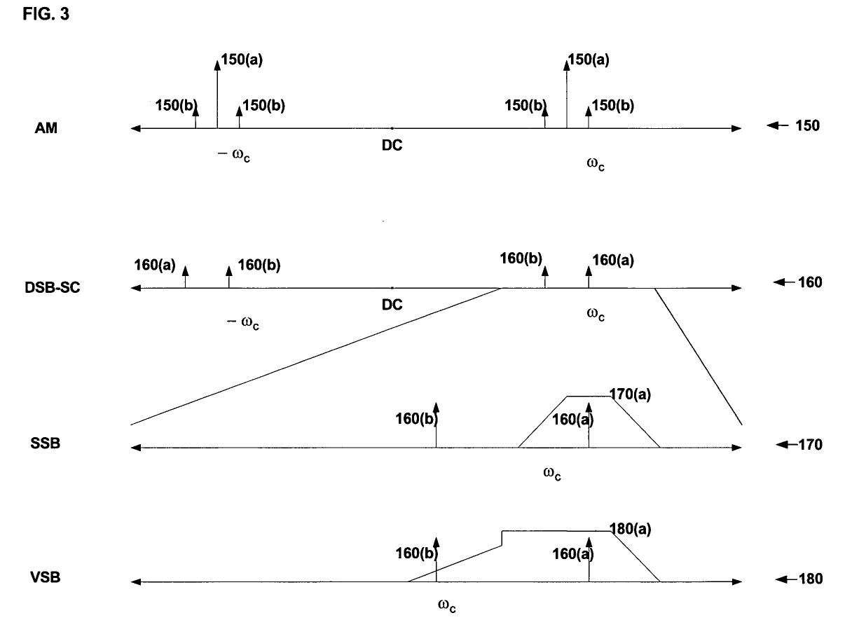

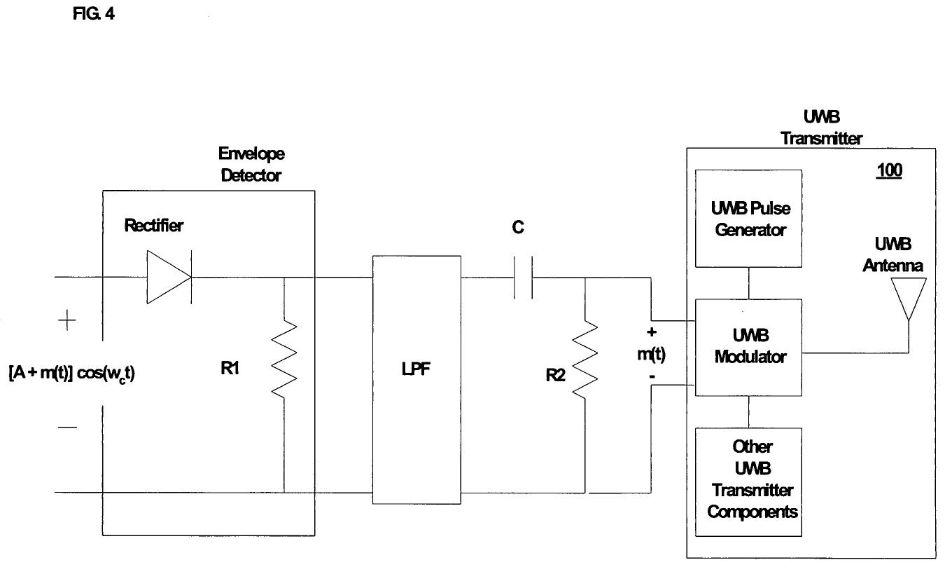

Referring to FIG. 3, in Amplitude Modulation (AM) the amplitude of the carrier signal is modulated with a data signal to produce a signal suitable for transmission. In conventional AM a data signal [A+m(t)], where A is a constant, is multiplied or mixed with a sinusoidal carrier signal to produce a composite signal that has the desired characteristics of baseband data on a carrier at a desired frequency. The resultant frequency spectrum 150, as shown in FIG. 3, where the larger impulses 150(a) represent the frequency of the carrier and the lower amplitude impulses 150(b) represent the frequency content of m(t).

A number of methods can be used to demodulate AM signals. Since the transmitted signal is the product [A+m(t)] cos(ω_{c}t), multiplying the received signal by a carrier at the same frequency will result in the following:

$$y ( t ) = [ A + m ( t ) ] cos ( {ω}_{c} t )$$

$$y ( t ) cos ( {ω}_{c} t ) = [ A + m ( t ) ] {cos}^{2} ( {ω}_{c} t )$$

$$y ( t ) cos ( {ω}_{c} t ) = \frac{1}{2} [ A + m ( t ) ] [ 1 + cos ( 2 {ω}_{c} t ) ]$$

$$y ( t ) cos ( {ω}_{c} t ) = \frac{1}{2} [ A + m ( t ) ] + \frac{1}{2} [ A + m ( t ) ] [ cos ( 2 {ω}_{c} t ]$$

The resultant signal can then be filtered with a low pass filter having a cutoff frequency below 2ω_{c}t, which will attenuate the high frequency portion of the signal. After blocking the DC portion (A) the desired signal m(t) is recovered. Since this coherent or homodyne receiver architecture requires local generation and synchronization of a carrier frequency other methods of AM demodulation, such as the use of an envelope detector, have been developed and are well known in the art of communications.

Again referring to FIG. 3, another variant of AM is known as Dual Sideband Suppressed Carrier (DSB-SC). In DSB-SC the data, or modulating signal is directly multiplied with a carrier wave, without the DC constant A. The resultant signal y(t) can be expressed as y(t)=m(t) cos(ω_{c}t). Since the constant A is no longer present in the transmitted signal, the carrier and its associated power is not separately transmitted. The DSB-SC frequency spectrum 160 signal is shown in FIG. 3, where the frequency content of m(t) is centered in two sidebands 160(a) and 160(b) that are symmetric around the carrier frequency ω_{c}. Since the carrier is not present in the received signal a coherent or homodyne receiver may be used to demodulate the DSB-SC signal.

As shown in FIG. 3, the signal content is identical in both the upper sideband 160(a) and the lower sideband 160(b). Another variant of AM has been developed that exploits this symmetry. In Single Sideband (SSB) transmission 170, one of the two sidebands is transmitted. In some implementations of SSB a bandpass filter 170(a) is used to select one sideband and attenuate the other. The signal is then transmitted. In another implementation the DSB-SC signal is passed through a filter that delays the frequency components by π/2 without changing the amplitude of the signal. This process implements the Hilbert Transform of the original DSB-SC yielding a single sideband. Demodulation of SSB signals is similar to DSB signals. If the carrier is present in the SSB signal, SSB+C, then non-coherent demodulation, with envelope detection as discussed above, is possible. In the case where the carrier is not present, coherent demodulation is required.

There are inherent difficulties in the generation of SSB signals. Generation by phase shift, the Hilbert Transform method discussed above, requires the use of a filter that is only partially realizable. Systems employing that method typically use an approximation of the perfect filter. The selective bandpass filtering method requires a DC null in the modulating signal spectrum. DSB-SC signals are significantly easier to generate but consume twice the bandwidth of the SSB signals. With these difficulties in mind another variant of AM called Vestigial Sideband (VSB) signal transmission 180 has been developed and is widely used in analog CATV systems. VSB is similar in nature to a SSB selective filtering in that a bandpass filter is used to pass one sideband and attenuate the other sideband. As shown in FIG. 3, VSB 180 differs from SSB 170 in that the filter 170(a) is asymmetric and allows a gradual cutoff of the rejected sideband. The bandwidth of the VSB signal is approximately 25% greater than the SSB signal but avoids many of the above difficulties in SSB systems.

Demodulation of VSB signals is similar to SSB signals. When the carrier is present in the VSB signal, known as VSB+C, non-coherent demodulation with an envelope detector is possible. When the carrier is not present, the demodulation is accomplished with a coherent demodulator as described above.

Another modulation technique that involves AM is known as Quadrature Amplitude Modulation (QAM). In QAM two carriers are amplitude modulated with data. The carriers are orthogonal with respect to each other, which allows for simultaneous transmission and reception without interference between the carriers. In QAM a single carrier, cos(ω_{c}t) is generated and phase shifted by π/2 to produce sin(ω_{c}t). The in-phase (I) channel is the cos(ω_{c}t) carrier and the quadrature (Q) channel is the sin(ω_{c}t) carrier. Two data signals m₁(t) and m₂(t) are then mixed with the I and Q channels to produce AM modulated carriers. The resultant signals are then summed prior to transmission. Since cos(ω_{c}t) and sin(ω_{c}t) are mutually orthogonal, this summation does not cause interference. QAM signals are demodulated in a similar coherent manner. A carrier cos(ω_{c}t) is generated at the same frequency and phase shifted to produce sin(ω_{c}t). These signals are mixed with the received signal and filtered with a lowpass filter to attenuate the high frequency components produced by mixing. The resulting signals are then recovered from the output of the lowpass filter.

A similar modulation technique called Orthogonal Frequency Division Multiplexing (OFDM) takes advantage of orthogonality constraints on carriers to extend this concept. In OFDM multiple data streams, or alternatively subsets of the same data stream are modulated onto a number of orthogonal carriers. OFDM can be accomplished with the use of a transformation matrix such as the Inverse Fast Fourier Transform (IFFT) matrix. In OFDM the data channels are multiplied by the IFFT matrix resulting in a set of modulated orthogonal carriers. The set of carriers may overlap in the frequency domain without interference due to their orthogonal nature.

Angle modulation methods include phase and frequency modulation. Unlike AM methods angle modulation methods are non-linear. In angle modulation methods the data is modulated onto the frequency or phase of the carrier wave. Recovering the instantaneous phase or frequency of the carrier demodulates the data. Angle modulated waveforms (PM for phase modulation, and FM for frequency modulation) can be mathematically described as:
PM(t)=A cos(ω_{c}t+kₚm(t))
FM(t)=A cos(ω_{c}t+k_{f}∫m(t)dt)

Demodulation of angle-modulated signals can be accomplished in a number of ways. On a mathematical basis the derivative of the above signals yields the following:

$$\frac{ⅆ}{ⅆ t} PM ( t ) = A ( {ω}_{c} + {k}_{p} \frac{ⅆ m ( t )}{ⅆ t} ) sin ( {ω}_{c} t + {k}_{p} m ( t ) )$$

$$\frac{ⅆ}{ⅆ t} F M ( t ) = A ( {ω}_{c} + {k}_{f} m ( t ) ) sin ( {ω}_{c} t + {k}_{f} \int m ( t ) ⅆ t )$$

Since the resultant signals are both amplitude and angle modulated, an envelope detector may be used to detect the amplitude component of the signals yielding the following:

$${y}_{p} = A ( {ω}_{c} + {k}_{p} \frac{ⅆ m ( t )}{ⅆ t} )$$

$${y}_{f} = A ( {ω}_{c} + {k}_{f} m ( t ) )$$

In both cases the data signal m(t) may then be recovered.

A method of demodulation using a Phase Locked Loop (PLL) is additionally known in the art and is in wide use for angle modulated signals. In a PLL circuit a Voltage Controlled Oscillator (VCO) provides a reference signal at the carrier frequency. The output of the VCO is multiplied or mixed with the incoming signal. This produces a signal with a low frequency component and a frequency component at approximately twice the carrier frequency. This signal is lowpass filtered to attenuate the high frequency component. The resulting low frequency signal is proportional to the difference between the instantaneous frequency of the incoming signal and the locally generated carrier frequency. This error signal is therefore proportional to the data contained in the incoming signal.

Regarding communication techniques for ultra-wideband (UWB) technology, two different development paths have recently appeared. One path known as multi-band UWB generates UWB signals of longer duration in time with differing center frequencies. In this approach to UWB, the pulses may occupy bandwidths of hundreds of MHz. In this type of UWB system the frequency bands may be used to provide a method of data modulation or may provide channelization for users in a UWB network. In one UWB multi-band modulation technique the data is carried on the frequency bands that the UWB pulse occupies. In another modulation technique the data is represented by the sequence in time that each frequency band is hopped. When used for channelization, different users occupy different frequency bands. In one multi-band approach the UWB pulses are generated to be orthogonal which will allow for overlap of occupied frequency bands.

In another UWB implementation the pulse duration, or width may be configured so that the frequency bandwidth occupied by the pulse is significantly larger than the multi-band approach. As discussed above, the frequency band of a single UWB pulse may be several Gigahertz. In this “single-band” UWB communication method system, processing gain and increased immunity to narrowband interference are an inherent feature of the increased pulse bandwidth. Additionally, since the pulse or pulses occupy a significantly larger bandwidth, each individual pulse may be transmitted at a higher power level and still stay within the emission limits established by the Federal Communications Commission. The higher power pulses of a single-band UWB system can be detected at a greater distance than the pulses of a multi-band UWB system. Additionally, since the multi-band UWB system may require a multiplicity of bandpass filters on the receiver, single-band receivers are usually less complicated and cheaper to build.

One feature of the present invention is that it provides methods of bridging data between different communication media, such as air (wireless) and cable, or copper (wire). However, the physical characteristics of different wire transmission media yield differences in their bandwidth capacity, and the present invention may change a variety of communication parameters in recognition of these differences. For example, coaxial cables used in the distribution of CATV signals are shielded and the usable bandwidth is approximately 750 to 800 MHz. The bandwidth of the Plain Old Telephone System (POTS) has been utilized by some DSL systems up to approximately 30 MHz. In powerline communication systems, the useful bandwidth within the home or office may only be 20-30 MHz. Generally, the specific category rating of a twisted-pair wire, or cable determines its useful bandwidth.

Other considerations are important when transmitting UWB pulses on some media. Some wire media are shielded, which reduces the amount of emissions radiated when a signal is present. Shielded systems are therefore capable of higher transmission powers. Since UWB communication systems can spread the electromagnetic pulse energy across the available bandwidth, communications parameters may be adapted for the specific media used for transmission. Some transmission media have different inherent noise characteristics that may also be considered when transmitting UWB pulses. Additionally, in some communication media, there may be other communication signals present. In those situations, the UWB pulses may need to be altered to ensure coexistence with the other communication signals.

One embodiment of the present invention provides methods of providing different communication system parameters for UWB pulses based on the media characteristics described above. For example and not by way of limitation, a QAM signal may be received from a CATV system containing digital television video and audio content. The signal may be demodulated and retransmitted across a wireless UWB link using PPM modulation, with a pulse transmission rate of 100 MHz, using 400 picosecond duration pulses, each having a center frequency of about 4.25 GHz. In another example, an audio signal may be received from an FM radio station, demodulated and retransmitted across the powerlines of a home in a UWB format using On-Off-Keying (OOK), with a pulse transmission rate of about 1 MHz, with pulse durations of about 100 nanoseconds, each having a center frequency of about 5 MHz. In addition, both signals may be received in other parts of the home by UWB enabled transceivers.

In one feature of the present invention, the routing decision to determine which media to utilize for transmission may be based on the current UWB communication load present on the available media and the bandwidth demand on each medium. Additional considerations may be the bandwidth capacity of each medium and the bandwidth demand of the communications being transmitted. For example, high-definition (HD) video and audio may be appropriate for a wireless transmission medium or for a coaxial medium, but may not be appropriate for a powerline medium or a phone line due to the inherent bandwidth requirement for HD video and the limitations of the phone and power lines.

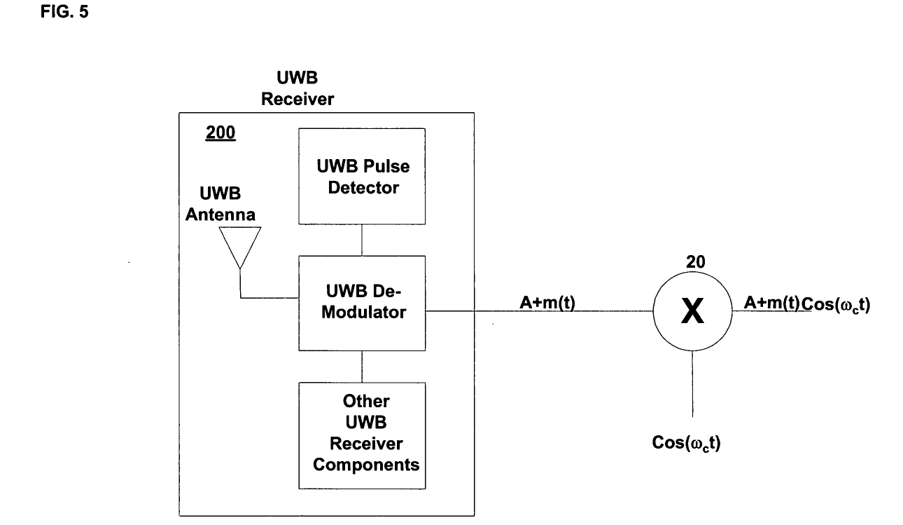

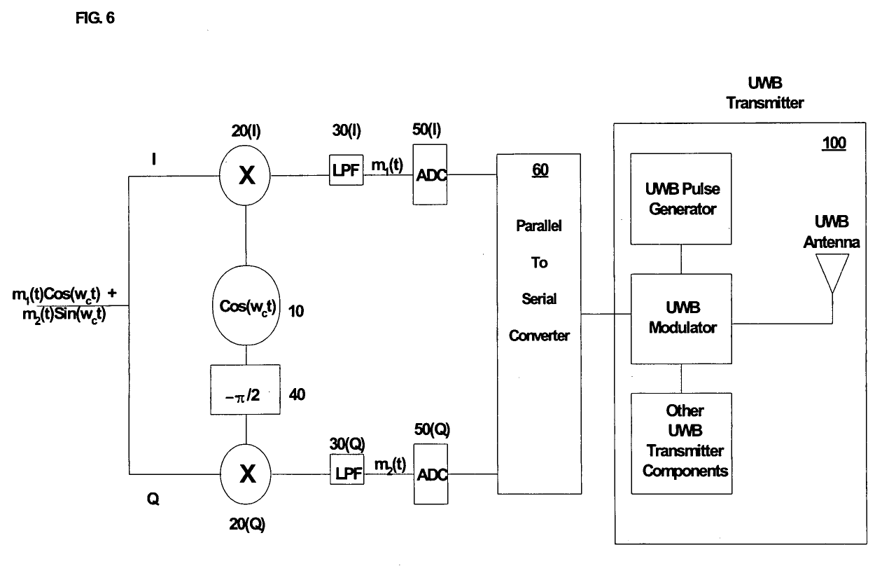

Referring to FIGS. 4 and 5, which illustrate the bridging of carrier based AM communications to and from a UWB transceiver, according to one embodiment of the present invention. The continuous AM waveform [A+m(t)]cos(ω_{c}t) arrives at the envelope detector comprised of a rectifier circuit, a resistive element R1, and any other suitable components, or their equivalents. As described above, the envelope detector's output is filtered by lowpass filter LPF. Capacitive element C blocks residual DC present in the signal and the recovered data signal m(t) is sent to the UWB transmitter 100. The UWB transmitter 100 may comprise a UWB modulator, a pulse generator and other UWB transmitter components, such as amplifiers, bandpass filters, transmit/receive switches to name a few. This form of non-coherent AM demodulation may be employed in demodulating any of the above-described AM variant signals when the carrier is present in the transmitted signal, such as AM, SSB+C, VSB+C (as discussed in connection with FIG. 3).

Referring again to FIG. 5, in like manner a UWB receiver 200 comprised of an UWB antenna, pulse detector, UWB demodulator, and other UWB receiver components such as amplifiers, filters and a transmit/receive switch, receives a UWB signal and recovers the data in the form [A+m(t)]. This data signal is then mixed 20 with a carrier wave cos(ω_{c}t) to produce an AM continuous waveform suitable for transmission. As is well known in the art of communications a number of other AM modulation and demodulation circuits may be used to practice the invention.

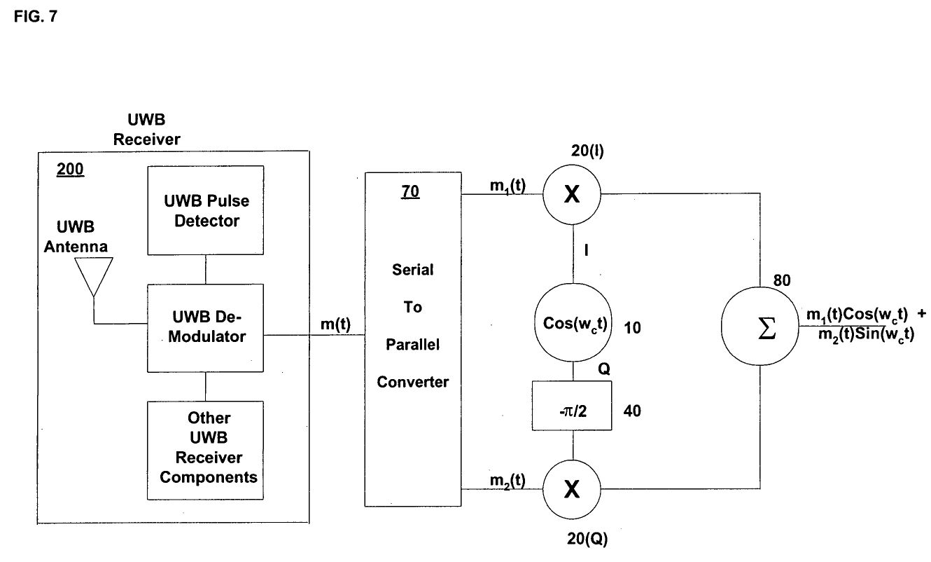

Referring now to FIGS. 6 and 7, which illustrate the bridging of carrier based QAM signals to and from a UWB transceiver. A continuous carrier based QAM signal m₁(t) cos(ω_{c}t)+m₂(t)sin(ω_{c}t) is received. A local oscillator 10 generates a sinusoidal signal at the same frequency of the received signal cos(ω_{c}t). The locally generated signal is split between two channels I and Q. Phase shifter 40 imparts

$$a - \frac{π}{2}$$

to the local signal for the Q channel. The incoming QAM signal is mixed with the two locally generated signals by mixers 20(I) and 20(Q). The resultant product of mixing contains a low frequency component and a frequency component at approximately twice the carrier frequency. Low pass filters (LPFs) 30(I) and 30(Q) attenuate the high frequency component of the mixed signals. The original data signals m₁(t) and m₂(t) are recovered from the output of the LPFs 30(I) and 30(Q). The signals m₁(t) and m₂(t) may then be quantized by Analog to Digital Converters (ADCs) 50(I) and 50(Q). Parallel to Serial Converter 60 takes the two quantized signals and interleaves them to produce one serial data stream. The data stream is then sent to the UWB transmitter 100 which may comprise a UWB modulator, a pulse generator and other UWB transmitter components such as amplifiers, Analog to Digital Converters, bandpass filters, transmit/receive switches, or their equivalents, to name a few.

Referring again to FIG. 7, in like manner a UWB receiver 200 comprised of an UWB antenna, pulse detector, UWB demodulator, and other UWB receiver components such as amplifiers, filters and a transmit/receive switch, receives a UWB signal and recovers the data in the form m(t) This data signal split into two signals m₁(t) and m₂(t) by Serial to Parallel Converter 70. Alternatively, the signals m₁(t) and m₂(t) may be from two distinct UWB receivers 200. In that embodiment, the Serial to Parallel Converter 70 is not used. A local oscillator 10 generates a carrier wave cos(ω_{c}t) at the desired frequency ω_{c}. The locally generated signal is split into two channels I and Q. The locally generated signal on the Q channel is then shifted

$$- \frac{π}{2}$$

in phase by phase shifter 40. The data signals m₁(t) and m₂(t) are then mixed with the carrier waves and summed by summer 80 to produce a QAM continuous waveform suitable for transmission. As is well known in the art of communications a number of other QAM modulation and demodulation circuits may be used to practice the invention.

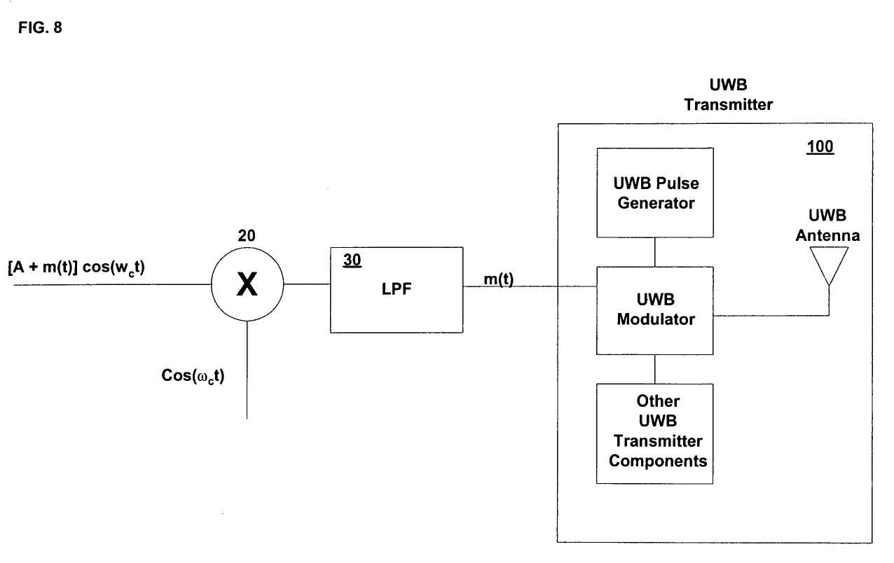

Referring now to FIG. 8, which illustrates coherent demodulation of an AM signal. A continuous AM waveform is received. It is anticipated that the continuous AM waveform may be DSSB-SC, VSB, SSB (as discussed above in connection with FIG. 3) or the AM waveform depicted in FIG. 8. It is additionally known in the art of communications that a coherent demodulator may be used when a carrier is present in the received waveform. A local carrier cos(ω_{c}t) is generated and mixed with the incoming signal by mixer 20. The resultant signal is then filtered by low pass filter (LPF) 30 to eliminate the high frequency component produced by mixing the signal with the locally generated carrier to recover the data signal m(t). The data signal is then retransmitted by UWB transmitter 100 which may comprise a UWB modulator, a pulse generator and other UWB transmitter components such as amplifiers, Analog to Digital Converters, bandpass filters, transmit/receive switches, and their equivalents, to name a few. The filter 30 may be an asymmetric bandpass filter in the case of VSB demodulation. Other coherent demodulation techniques involving signal squaring are known and are included within the scope of the invention as well.

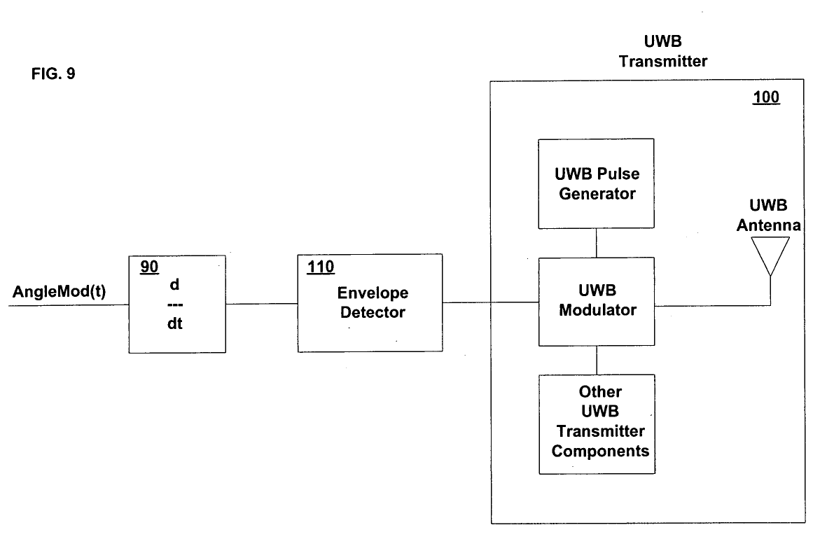

Referring to FIG. 9, which illustrates the reception, demodulation of an angle modulated signal, and retransmission of data employing UWB pulses. As described above, angle modulated signals carry data in the instantaneous frequency or phase of the signal. The angle-modulated signal is received and differentiated by differentiator 90. The resultant signal is then applied to an envelope detector circuit 110. The envelope detector 110 returns the amplitude of the derivative of the angle-modulated signal. As described above, the data signal can then be recovered from the output of the envelope detector 110. The signal is then sent to the UWB transmitter 100 which may comprise a UWB modulator, a pulse generator and other UWB transmitter components such as amplifiers, Analog to Digital Converters, bandpass filters, transmit/receive switches, and their equivalents, to name a few.

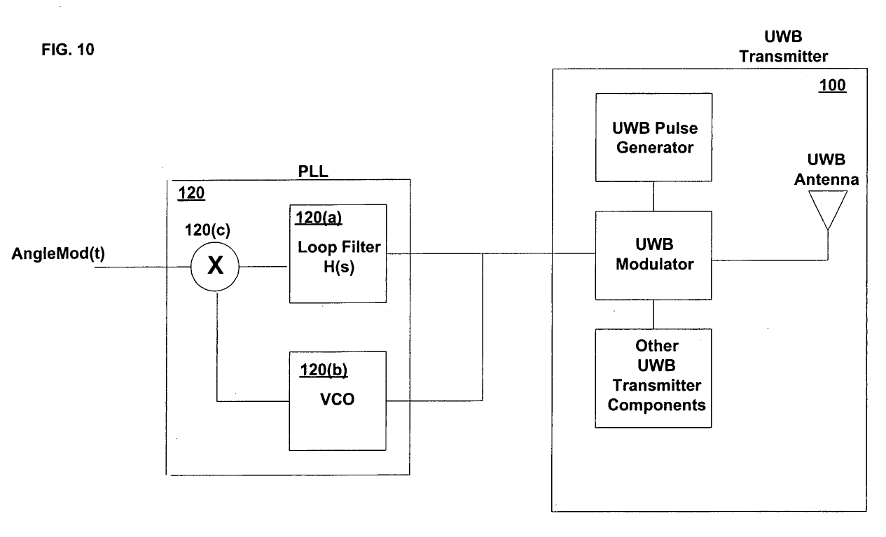

Referring specifically to FIG. 10, which illustrates another embodiment of the present invention. In this embodiment, the angle-modulated signal is received and sent to the phase-locked-loop (PLL) circuit 120. PLL circuit 120 comprises a multiplier 120(c), a loop filter 120(a), and a voltage controlled oscillator (VCO) 120(b). The output of the VCO 120(b) is multiplied with the incoming signal by multiplier 120(c). The resultant product has a low frequency component proportional to the difference in the frequency and phase of the two signals. Additionally, the product has a frequency component at approximately twice the carrier frequency. Loop Filter 120(a) has a cut-off frequency low enough to significantly attenuate this high frequency component. The output of the Loop Filter 120(a) is then fed back to the VCO as a control signal. Once the PLL is locked to the incoming waveform, the output of the Loop Filter 120(a) is zero since the signal generated by the VCO and the incoming signal are coherent in both frequency and phase. As the incoming signal changes in instantaneous frequency or phase due to the data, the output of the Loop Filter 120(a) is proportional to that change and therefore to the data carried by the signal. The data is then sent to a UWB transmitter 100 which may comprise a UWB modulator, a pulse generator and other UWB transmitter components such as amplifiers, Analog to Digital Converters, bandpass filters, transmit/receive switches, and their equivalents, to name a few. The UWB transmitter 100 then re-transmits the data employing UWB pulses. It is anticipated that other angle demodulation techniques may be employed by the present invention.

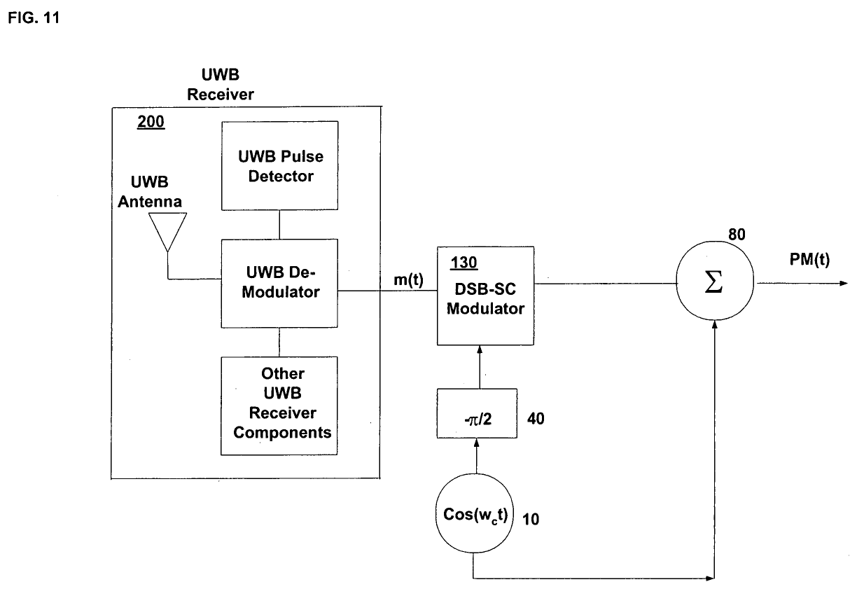

Referring now to FIG. 11, which illustrates the reception of a UWB signal and retransmission as a phase angle (PM(t)) modulated signal. UWB receiver 200 receives and demodulates m(t) from a UWB signal. Local oscillator 10 provides a locally generated carrier signal at the desired frequency ω_{c}. The locally generated signal is split and one signal is shifted

$$- \frac{π}{2}$$

in phase by phase shifter 40. The data signal is then modulated onto the phase-shifted signal by DSB-SC as described above. The modulated signal is then summed with the original non-phase shifted signal by summer 80. The resultant signal is an phase angle-modulated signal (PM(t)) where the data is carried by the instantaneous phase of the carrier. Other phase modulation techniques are known in the art and may be used to practice the invention as well.

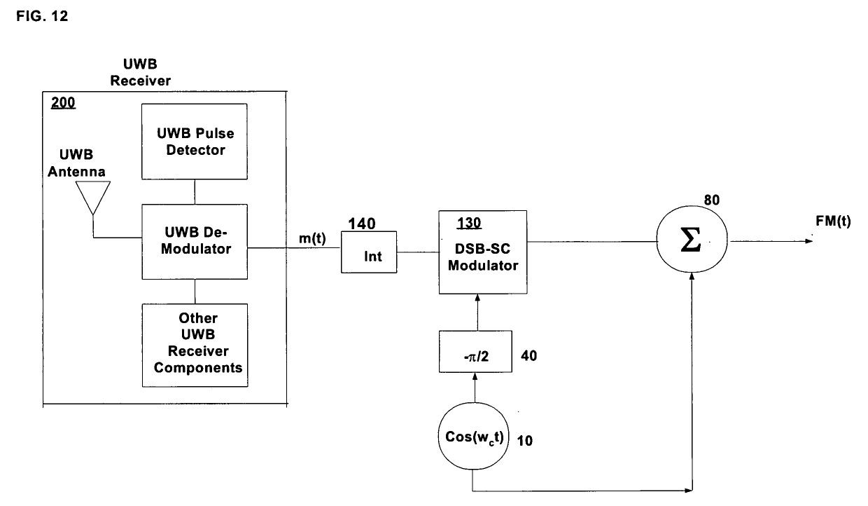

Referring specifically to FIG. 12, which illustrates the reception of a UWB signal and retransmission as an frequency angle modulated signal (FM(t)). UWB receiver 200 receives and demodulates m(t) from a UWB signal. Local oscillator 10 provides a locally generated carrier signal at the desired frequency ω_{c}. The locally generated signal is split and one signal is shifted

$$- \frac{π}{2}$$

in phase by phase shifter 40. The data signal is then integrated by integrator 140 and modulated onto the phase-shifted signal by DSB-SC as described above. The modulated signal is then summed with the original non-phase shifted signal by summer 80. The resultant signal is a frequency angle-modulated signal (FM(t)) where the data is carried by the instantaneous frequency of the carrier. Other frequency modulation techniques are known in the art and may be used by the present invention as well.

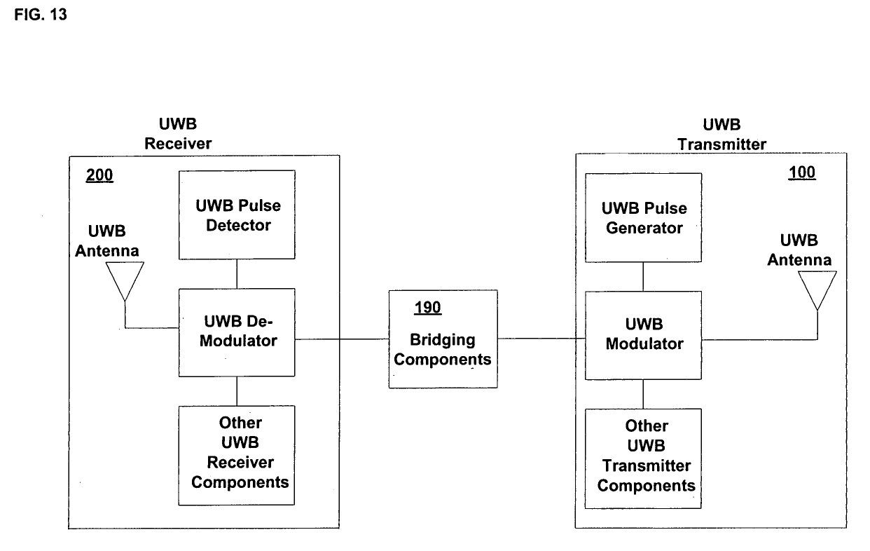

Referring now to FIG. 13, which illustrates bridging data from one UWB protocol, or format to another UWB format. As described above, UWB communication may employ a multi-band approach or a single-band approach. In one embodiment of the present invention, UWB communication signals, in the form of a plurality of UWB pulses, are received by UWB receiver 200. As illustrated, the UWB receiver 200 may include an UWB antenna, a UWB pulse detector, a UWB demodulator, and other UWB receiver components, as described above. After the data is demodulated, it is re-formatted by bridging components 190 which may include a multiplicity of bandpass filters, a multiplicity of Analog to Digital converters, a multiplicity of amplifiers, parallel to serial converters, and serial to parallel converters to name a few components that may be used to reformat UWB pulses received in either a multi-band format or a single-band format for transmission in either a multi-band format or a single-band format. Transmission of the UWB pulses is through UWB transmitter 100. As illustrated, the UWB transmitter 100 may include an UWB antenna, a UWB pulse generator, a UWB modulator, and other UWB transmitter components, as described above. Generally, in a case where multi-band formatted UWB pulses are received, the bridging components 190 would shorten, or shape the UWB pulses. For example, a multi-band UWB pulse may have a duration of about 2 nanoseconds, which corresponds to about a 500 MHz bandwidth. However, a single-band UWB pulse may have a duration of about 400 picoseconds, which corresponds to about a 2.5 GHz bandwidth.

In another embodiment of the present invention, the bridging components 190 may include buffers to be used when bridging UWB communication pulses to and from media requiring different pulse durations. Additionally, this embodiment may include pre-distortion and other pulse shaping circuits to optimize the UWB pulses for the second transmission medium.

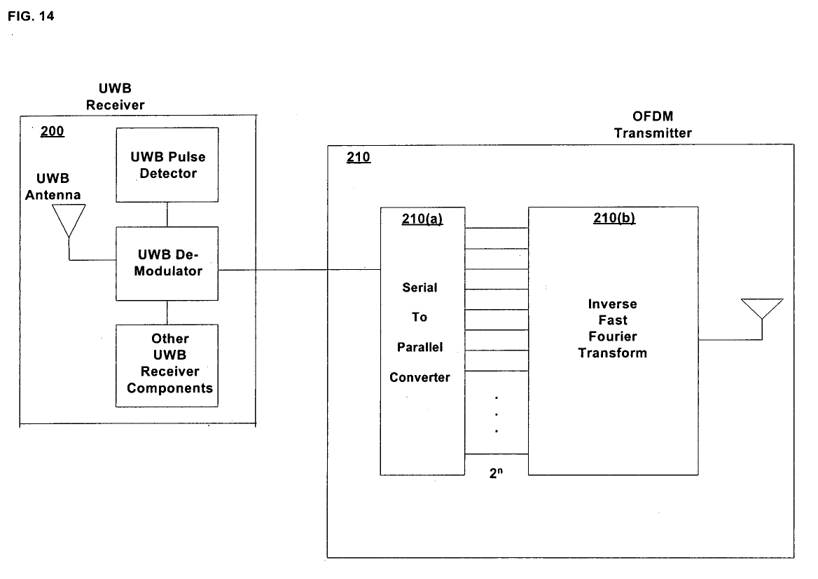

Referring to FIG. 14, which illustrates the bridging of UWB formatted data to a conventional sine wave OFDM communication format, or protocol. UWB receiver 200 (constructed as described above) receives a plurality of UWB pulses. The data is demodulated from these pulses and sent to OFDM transmitter 210. As described above, OFDM transmitter comprises Serial to Parallel Converter 210(a) which converts the data signal into a parallel data set. Orthogonal transformation of the parallel data set is accomplished by Inverse Fast Fourier Transform 210(b) resulting in an OFDM signal, which is then transmitted using known conventional, narrowband signal transmission methods.

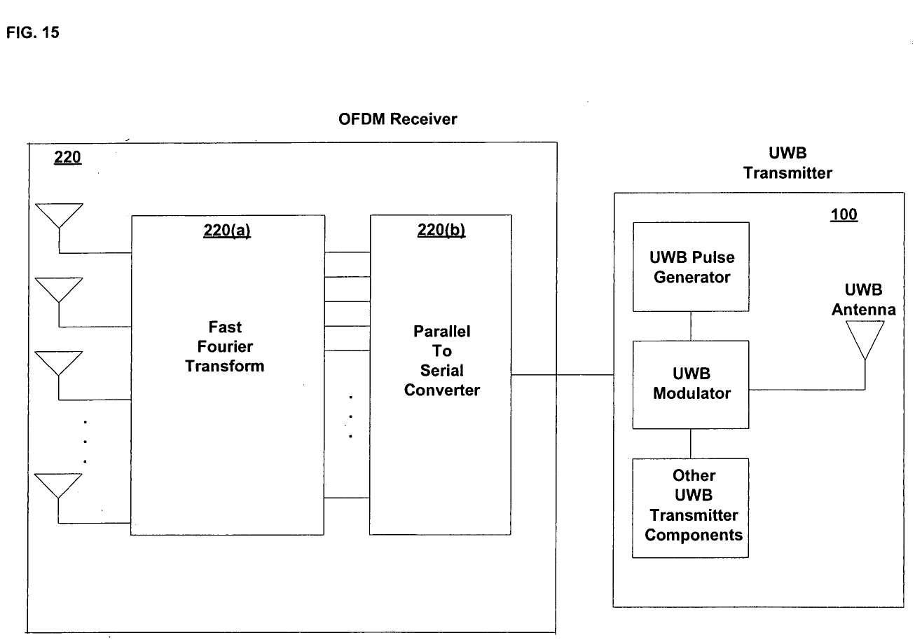

Referring now to FIG. 15, which illustrates the bridging of conventional, narrowband OFDM signals to UWB pulses. The OFDM receiver 220 may comprise a multiplicity of receiver chains (not shown), an orthogonal matrix transformation such as a Fast Fourier Transform 220(a), and a Parallel to Serial Converter 220(b). In practice, the OFDM receiver 220 receives an OFMD data signal, demodulates and serializes the data and sends it to the UWB transmitter 100. The UWB transmitter 100 retransmits the data in a UWB format employing a plurality of UWB pulses. This is accomplished by modulating the data using a UWB modulator, a UWB pulse generator, a UWB antenna, and other UWB transmitter components, as described above.

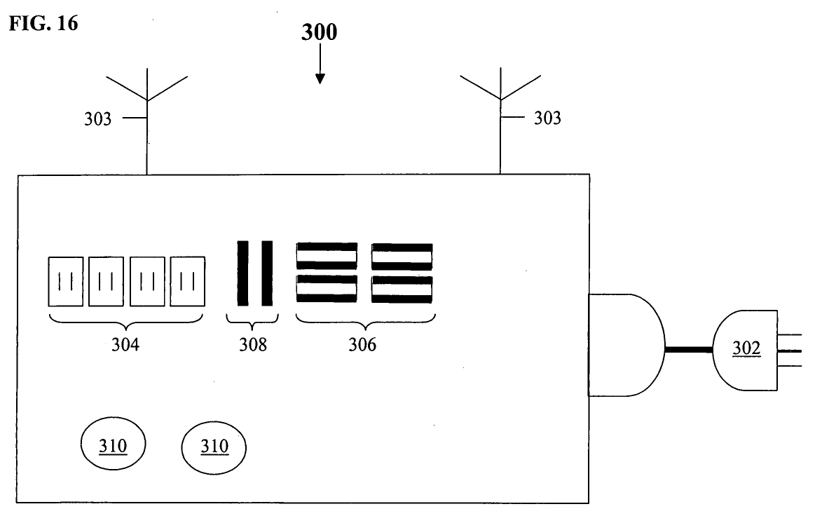

FIG. 16 illustrates one embodiment of a gateway or bridge 300 constructed according to the present invention. In this embodiment the gateway 300 has a number of different communication media interfaces. These interfaces can include, but are not limited to, coaxial cable 310, power plug, or power line 304, IEEE-1394 (not shown), twisted pair wire, such as phone lines 306, CAT 5 Ethernet 308, wireless interfaces, such as antennas 303, S-Video cable interfaces (not shown), Universal Serial Bus interfaces (not shown), fiber optic cable (not shown), and any other type of communication media interfaces. Various embodiments of the gateway or bridge 300 may include some, or all of the components, features and functionality described above in connection with FIGS. 4-15. In the illustrated embodiment, the gateway 300 includes 201 a cable, or connector 302 that obtains electrical power from an electrical power outlet, or alternatively, the gateway 300 may be wired directly to an electrical power source.

One feature of the present invention is that it may perform the physical interface, logic and routing functions of bridging, or transferring ultra-wideband (UWB), and non-UWB formatted data between dissimilar media types (wire and wireless). As mentioned above, the present invention provides a system, methods, and apparatus that can communicate between, or “bridge” between different communications technologies.

In one embodiment, the gateway 300 may translate, or convert data that it receives to a common data format that is independent of the type of physical interface, or communication media that was used to transport it to the gateway 300. This common data format would include, or preserve the received data, and the routing, or destination information and the Quality of Service (QoS) information as well (QoS parameters may be expressed in bit-error-rate (BER) requirements). In addition, the common data format may also include, or preserve any priority requirements and any latency information.

The gateway 300 may then prepare, and transmit the data using the most appropriate communication media (wire or wireless). In this fashion, the common data format, in conjunction with associated hardware, functions as a “bridge” between different communication media.

For example, a television viewer in a residence may request a movie from a DVD player, that is in another room of the residence. The request may travel from the TV set-top-box to the gateway 300, that generates a UWB datastream, which is transmitted on the home's power line. The gateway 300 may send a request to the DVD player through the power line. The DVD player may then send the video stream to the gateway 300 via a UWB datastream modulated on a S-Video interface. The gateway 300 may then route the return DVD data via a UWB wireless link back to the TV's set-top-box. All these routing decisions are intelligently made and executed by the gateway 300 without user intervention.

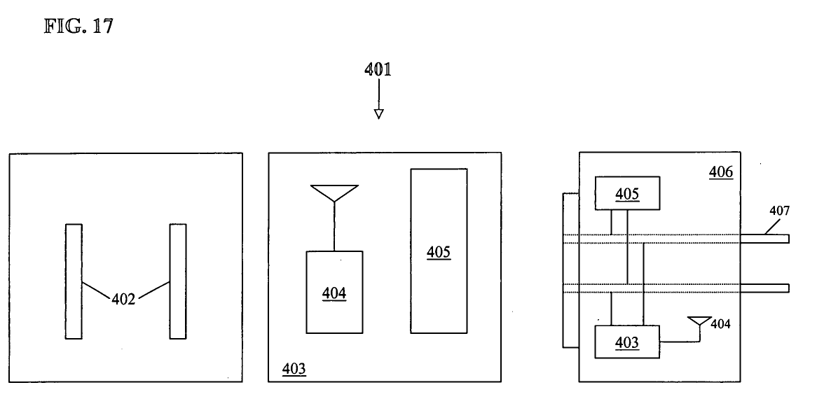

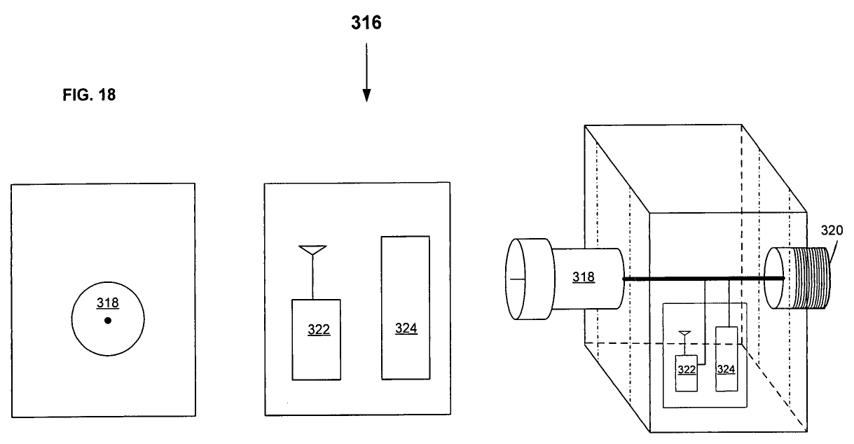

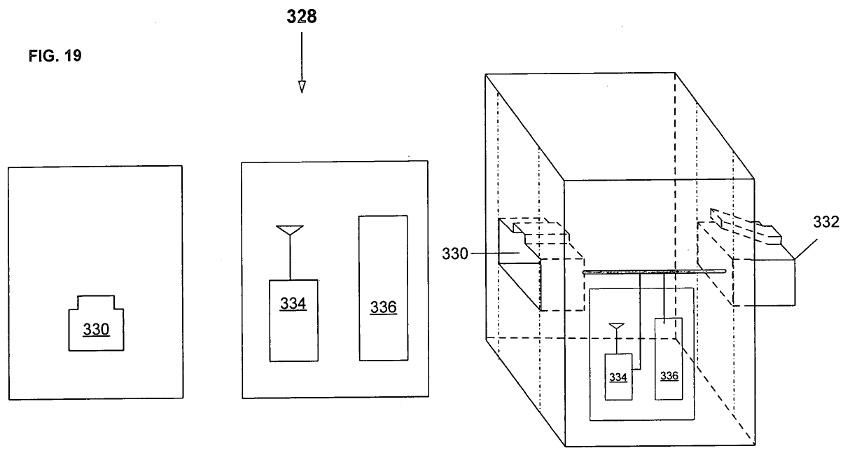

Referring to FIGS. 17-19, the gateway 300 may employ a variety of remote devices to achieve additional range and/or functionality. FIG. 17 depicts one embodiment of a power line transceiver 401, FIG. 18 depicts one embodiment of a coaxial cable transceiver 316, and FIG. 19 depicts one embodiment of a CAT 5 or phone line transceiver 328. These transceivers may extend the range of a transmitted signal, and each transceiver may be addressable from the gateway 300. For example, the gateway 300 may send a wireless signal to a room, where one of the above transceivers 401, 316, 328 receives and retransmits the signal. One feature of this embodiment of the present invention is that it allows the gateway 300 to communicate over extended ranges. In one embodiment the transceivers may be directed to retransmit the signal on a different media. For example, the remote transceivers 401, 316, 328 may have both wired media and wireless media transceivers.

Specifically, as shown in FIG. 17, the power line transceiver 401 includes may be employed in any room, or other area of a structure that has electrical power outlets (not shown). The plug-in transceiver 401 is removably coupled to the electrical power outlet by male connectors 407. The male connectors 407 may be electrically conductive pins or plugs, and they may be sized and configured to fit female power outlets of any configuration. For example, the male connectors 407 may be sized to fit a 110 volt, 3-slot power female outlet; a 110 volt, 2-slot female power outlet; a 220 volt, 240 volt or greater voltage female power outlet that may be configured for Europe, Japan, or any other country. The female slots 402 may be sized and configured to receive any arrangement of male pins or plugs.

As shown in FIG. 17, the power line transceiver 401 includes an ultra-wideband (UWB) wire media transceiver 405. The power line transceiver 401 may also include a wireless transceiver 403 that has an ultra-wideband antenna 404. Alternatively, the power line transceiver 401 may have a single transceiver (not shown) that includes an ultra-wideband antenna 404, with the single transceiver constructed to transmit and receive both wired and wireless UWB pulses, or signals.

Thus, the power line transceiver 401 may communicate with the gateway 300 through the structure's power lines, or wirelessly. The power line transceiver 401 may function as a relay, by forwarding wireless UWB pulses, or signals through the power line to a UWB enabled device that is coupled to the power line transceiver 401.

Referring to FIG. 18, the coaxial transceiver 316 may also function as a data relay. The coaxial transceiver 316 includes a female coaxial (coax) connector 318, a male coax connector 320, a wireless transceiver 322 and a wire transceiver 324. The coaxial transceiver 316 may receive either ultra-wideband data wirelessly or through the coaxial cable. In addition, the coaxial transceiver 316 may receive data that is formatted using conventional, narrowband protocols through the coax cable, and subsequently transmit the data using ultra-wideband technology (UWB), as described herein. Alternatively, the coaxial transceiver 316 may receive UWB-formatted data from the gateway 300, and re-transmit the data, either wirelessly, or through the coaxial cable.

Similarly, as shown in FIG. 19, the phone line, or CAT 5 transceiver 328 may also function as a data relay. The CAT 5 transceiver 328 includes a female connector 330, a male connector 332, a wireless transceiver 334 and a wire transceiver 336. The CAT 5 transceiver 328 may receive either ultra-wideband data wirelessly or through the CAT 5 cable. In addition, the CAT 5 transceiver 328 may receive data that is formatted using conventional, narrowband protocols through the CAT 5 cable, and subsequently transmit the data using ultra-wideband technology (UWB), as described herein. Alternatively, the CAT 5 transceiver 328 may receive UWB-formatted data from the gateway 300, and re-transmit the data, either wirelessly, or through the coaxial cable. It will be appreciated that other types of connectors may be employed in this embodiment. For example, CAT 7, CAT 4, CAT 3, CAT 2, CAT 1, and other types of wire connectors may be employed.

In one envisioned method of operation, the gateway 300 receives and segments a communication signal, that may be either a conventional, narrowband signal or an UWB signal. Functions performed by the gateway 300 include receiving, transmitting, I/O control, routing, addressing, modulation, demodulation, load balancing, appropriate UWB pulse width and envelope shape determination for the media, appropriate pulse recurrence frequency, or pulse transmission rate determination, buffering and reformatting incoming data for reception and transmission into other conductive media capable of supporting UWB transmissions. It is anticipated that the received data may or may not include UWB formatted data.

The signal is demodulated, and the data, destination and source addresses are preserved. In addition, the priority, latency and Quality Of Service (QOS) requirements are preserved, and the type of data is identified (voice, video, ect.). Additionally, the gateway 300 may perform error detection and correction prior to reassembly and retransmission of the data. Using the above information, the gateway 300 decides which media type to employ for re-transmission (wire, or wireless). The gateway 300 then assembles a suitable frame structure, re-modulates the data and retransmits the data on the selected media. One feature of this embodiment is that it allows for a guaranteed QoS level by checking the integrity of data frames or packets prior to retransmission.

In another embodiment, the gateway 300 allocates bandwidth resources to provide maximum data rates to each of the interfaced media without the use of a discovery protocol for devices on the media. In another embodiment of the present invention, a gateway 300 provides for load balancing of outgoing data. In this embodiment, the gateway 300 may require a discovery protocol for identification of device requirements on each interfaced media. In this embodiment, a more intelligent load balancing may be employed. By tracking the requirements of each device, the gateway 300 is able to route communications to under-utilized media.

Communication between the gateway 300 and any of the transceivers 401, 316 328, or to other devices may be accomplished over one or more of the following: power lines, phone lines, wirelessly, coaxial cable and installed twisted-pair wires. The preferred embodiment has additional interfaces to support Ethernet, Giga-bit Ethernet, IEEE 1394 and USB. This embodiment intelligently bridges UWB communications to and from all wired and wireless interfaced media. For example, a coaxial cable that is connected to the gateway 300 may have a UWB datastream coexisting with other frequency modulated data. The gateway 300 detects and extracts the encoded UWB data from the coax cable, and determines the destination and optimal routing of the data. For example, the data enters the home on coax, but may routed from the gateway 300 via a UWB wireless link. The gateway 300 may be employed in any structure where a need for communication exists, such as, a home, business, university building, hospital or any other structure.

Thus, it is seen that a system and method for bridging data between different communication technologies and media is provided. One skilled in the art will appreciate that the present invention can be practiced by other than the above-described embodiments, which are presented in this description for purposes of illustration and not of limitation. The description and examples set forth in this specification and associated drawings only set forth preferred embodiment(s) of the present invention. The specification and drawings are not intended to limit the exclusionary scope of this patent document. Many designs other than the above-described embodiments will fall within the literal and/or legal scope of the instant disclosure, and the present invention is limited only by the instant disclosure. It is noted that various equivalents for the particular embodiments discussed in this description may practice the invention as well.

1. A communication system comprising:
a receiver structured to receive a substantially continuous sine wave carrier signal, the signal modulated to contain communication data;
a demodulator communicating with the receiver, the demodulator structured to demodulate the communication data from the substantially continuous sine wave carrier signal; and
a transmitter coupled to the demodulator, the transmitter structured to transmit a plurality of electromagnetic pulses, with the pulses configured to include the communication data.

2. The communication system of claim 1, wherein the substantially continuous sine wave carrier signal is selected from a group consisting of: an amplitude modulated signal, a phase angle modulated signal, a frequency angle modulated signal, an orthogonal frequency division multiplexing modulated signal, a quadrature amplitude modulation signal, a dual sideband modulated signal, a single sideband modulated signal, and a vestigial sideband modulated signal.

3. The communication system of claim 1, wherein the substantially continuous sine wave carrier signal has a radio frequency bandwidth that may range between about 10 kilohertz to about 5 megahertz.

4. The communication system of claim 1, wherein the demodulator is selected from a group consisting of: an amplitude demodulation circuit, a quadrature amplitude demodulation circuit, a frequency angle demodulation circuit, a phase angle demodulation circuit, and an orthogonal frequency division demodulating circuit.

5. The communication system of claim 4, wherein the amplitude demodulation circuit is selected from a group consisting of: a dual sideband demodulation circuit, a single sideband demodulation circuit, and a vestigial sideband demodulation circuit.

6. The communication system of claim 2, wherein the dual sideband modulated signal has a suppressed carrier.

7. The communication system of 4, wherein the amplitude demodulation circuit comprises a low pass filter.

8. The communication system of claim 2, wherein the single sideband modulated signal has a suppressed carrier.

9. The communication system of claim 1, further including a first transmission medium coupled to the receiver, wherein the receiver receives the substantially continuous sine wave carrier signal through the first transmission medium.

10. The communication system of claim 9, wherein the first transmission medium is a wireless medium.

11. The communication system of claim 9, wherein the first transmission medium is selected from a group consisting of: an optical fiber ribbon, a fiber optic cable, a single mode fiber optic cable, a multi-mode fiber optic cable, a twisted pair wire, an unshielded twisted pair wire, a plenum wire, a PVC wire, a coaxial cable, and an electrically conductive material.

12. The communication system of claim 1, further including a second transmission medium coupled to the transmitter, wherein the transmitter transmits the plurality of electromagnetic pulses through the second transmission medium.

13. The communication system of claim 12, wherein the second transmission medium is a wireless medium.

14. The communication system of claim 12, wherein the second transmission medium is selected from a group consisting of: an optical fiber ribbon, a fiber optic cable, a single mode fiber optic cable, a multi-mode fiber optic cable, a twisted pair wire, an unshielded twisted pair wire, a plenum wire, a PVC wire, a coaxial cable, and an electrically conductive material.

15. The communication system of claim 1, wherein each of the plurality of electromagnetic pulses comprises an ultra-wideband pulse.

16. The communication system of claim 15, wherein each of the plurality of ultra-wideband pulses has a duration that ranges from about 10 picoseconds to about 10 milliseconds.

17. The communication system of claim 1, wherein the transmitter comprises an ultra-wideband pulse modulator that is structured to transmit a multiplicity of ultra-wideband pulses.

18. The communication system of claim 17, wherein the ultra-wideband pulse modulator is selected from a group consisting of: a pulse amplitude modulator, a pulse position modulator, a pulse duration modulator, a ternary pulse modulator, an on-off keying pulse modulator, a coded recurrence modulator, a sloped amplitude modulator, and a pulse phase modulator.

19. The communication system of claim 1, wherein each of the plurality of transmitted electromagnetic pulses occupies substantially the same radio frequency spectrum.

20. The communication system of claim 1, wherein each of the plurality of electromagnetic pulses is transmitted so that each pulse occupies a discrete portion of the radio frequency spectrum.

21. The communication system of claim 1, wherein the communication data is selected from a group consisting of: voice data, video data, audio data, and high-definition video data.

22. The communication system of claim 1, wherein the communication data is segmented into individual components selected from a group consisting of: received data, routing information, destination information, quality-of-service information, bit-error-rate information, priority information and latency information.

23. The communication system of claim 1, wherein the communication data is received in a first communication format, segmented, and re-assembled in a second communication format.

24. The communication system of claim 23, wherein the second communication format comprises an ultra-wideband communication format.

25. The communication system of claim 23, wherein the first communication format includes a format selected from a group consisting of: a substantially continuous sine wave carrier signal format; an amplitude modulated signal format, a phase angle modulated signal format, a frequency angle modulated signal format, an orthogonal frequency division multiplexing modulated signal format, a quadrature amplitude modulation signal format, a dual sideband modulated signal format, a single sideband modulated signal format, and a vestigial sideband modulated signal format.

26. A communication system comprising:
a receiver structured to receive a plurality of electromagnetic pulses, with the electromagnetic pulses configured to include communication data.
a demodulator communicating with the receiver, the demodulator structured to demodulate the communication data from the plurality of electromagnetic pulses; and
a transmitter coupled to the demodulator, the transmitter structured to transmit a substantially continuous sine wave carrier signal, the signal modulated to contain the communication data.

27. The communication system of claim 26, wherein the communication data is selected from a group consisting of: voice data, video data, audio data, and high-definition video data.

28. The communication system of claim 26, wherein the substantially continuous sine wave carrier signal is selected from a group consisting of: an amplitude modulated signal, a phase angle modulated signal, a frequency angle modulated signal, an orthogonal frequency division multiplexing modulated signal, a quadrature amplitude modulation signal, a dual sideband modulated signal, a single sideband modulated signal, and a vestigial sideband modulated signal.

29. The communication system of claim 26, wherein the substantially continuous sine wave carrier signal has a radio frequency bandwidth that may range between about 10 kilohertz to about 5 megahertz.

30. The communication system of claim 26, further including a first transmission medium coupled to the receiver, wherein the receiver receives the plurality of electromagnetic pulses through the first transmission medium.

31. The communication system of claim 30, wherein the first transmission medium is a wireless medium.

32. The communication system of claim 30, wherein the first transmission medium is selected from a group consisting of: an optical fiber ribbon, a fiber optic cable, a single mode fiber optic cable, a multi-mode fiber optic cable, a twisted pair wire, an unshielded twisted pair wire, a plenum wire, a PVC wire, a coaxial cable, and an electrically conductive material.

33. The communication system of claim 26, further including a second transmission medium coupled to the transmitter, wherein the transmitter transmits the substantially continuous sine wave carrier signal through the second transmission medium.

34. The communication system of claim 33, wherein the second transmission medium is a wireless medium.

35. The communication system of claim 33, wherein the second transmission medium is selected from a group consisting of: an optical fiber ribbon, a fiber optic cable, a single mode fiber optic cable, a multi-mode fiber optic cable, a twisted pair wire, an unshielded twisted pair wire, a plenum wire, a PVC wire, a coaxial cable, and an electrically conductive material.

36. The communication system of claim 26, wherein each of the plurality of electromagnetic pulses comprises an ultra-wideband pulse.

37. The communication system of claim 36, wherein each of the plurality of ultra-wideband pulses has a duration that ranges from about 10 picoseconds to about 10 milliseconds.

38. The communication system of claim 26, wherein the communication data is segmented into individual components selected from a group consisting of: received data, routing information, destination information, quality-of-service information, bit-error-rate information, priority information and latency information.

39. The communication system of claim 26, wherein the communication data is received in a first communication format, segmented, and re-assembled in a second communication format.

40. The communication system of claim 39, wherein the first communication format comprises an ultra-wideband communication format.

41. The communication system of claim 39, wherein the second communication format includes a format selected from a group consisting of: a substantially continuous sine wave carrier signal format; an amplitude modulated signal format, a phase angle modulated signal format, a frequency angle modulated signal format, an orthogonal frequency division multiplexing modulated signal format, a quadrature amplitude modulation signal format, a dual sideband modulated signal format, a single sideband modulated signal format, and a vestigial sideband modulated signal format.

42. A communication system comprising:
a receiver structured to receive a plurality of electromagnetic pulses, with the electromagnetic pulses configured to include communication data.
a demodulator communicating with the receiver, the demodulator structured to demodulate the communication data from the plurality of electromagnetic pulses; and
a transmitter coupled to the demodulator, the transmitter structured to transmit a plurality of electromagnetic pulses, the pulses configured to include communication data;
wherein the transmitted and received electromagnetic pulses are either a plurality of single-band electromagnetic pulses or a plurality of multi-band electromagnetic pulses.

43. The communication system of claim 42, wherein the communication data is selected from a group consisting of: voice data, video data, audio data, and high-definition video data.

44. The communication system of claim 42, wherein the plurality of single-band electromagnetic pulses have a radio frequency bandwidth that may range between about 2 gigahertz to greater than 10 gigahertz.

45. The communication system of claim 42, wherein the plurality of multi-band electromagnetic pulses have a radio frequency bandwidth that may range between about 200 megahertz to about 1 gigahertz.

46. The communication system of claim 42, further including a transmission medium coupled to either the receiver or the transmitter, wherein the receiver receives the plurality of electromagnetic pulses through the transmission medium, or the transmitter transmits the plurality of electromagnetic pulses through the transmission medium

47. The communication system of claim 46, wherein the transmission medium is a wireless medium.

48. The communication system of claim 46, wherein the transmission medium is selected from a group consisting of: an optical fiber ribbon, a fiber optic cable, a single mode fiber optic cable, a multi-mode fiber optic cable, a twisted pair wire, an unshielded twisted pair wire, a plenum wire, a PVC wire, a coaxial cable, and an electrically conductive material.
